(19) United States
(12) Patent Application Publication
(10) Pub. No.: US 2013/0141641 A1
(43) Pub. Date: Jun. 6, 2013

(54) IMAGE PROCESSING METHOD AND ASSOCIATED IMAGE PROCESSING APPARATUS

(71) Applicants: Yen-Hsing Wu, Hsin-Chu Hsien (TW); Hsin-Yuan Pu, Yunlin County (TW); Wen-Hau Jeng, New Taipei City (TW)

(72) Inventors: Yen-Hsing Wu, Hsin-Chu Hsien (TW); Hsin-Yuan Pu, Yunlin County (TW); Wen-Hau Jeng, New Taipei City (TW)

(21) Appl. No.: 13/615,488

(22) Filed: Sep. 13, 2012

(30) Foreign Application Priority Data
Dec. 5, 2011 (TW) 100144726

(51) Int. Cl. H04N 5/00; H04N 7/26

(52) U.S. Cl. 348/425.1; 348/606; 348/E05.096; 348/E07.045

(57) ABSTRACT

An image processing method includes: receiving a plurality of image frames; receiving a definition signal; and performing an noise reduction operation upon the image frames according to the definition signal, where the definition signal is utilized for representing a sharpness level of the image frames, and a degree of the noise reduction operation the image frames being processed is varied with the sharpness level of the image frames.

### BACKGROUND OF THE INVENTION

1. Field of the Invention

The present invention relates to an image processing method, and more particularly, to an image processing method and associated image processing apparatus that adjusts a degree of a noise reduction operation by referring to a sharpness level of a plurality of image frames.

2. Description of the Prior Art

Because television (TV) signals are degraded and interfered during signal transmitting, a receiver built in a TV will perform a noise reduction operation, such as temporal noise reduction, spatial noise reduction, interpolation of de-interlacing operation, sharpness adjustment, . . . etc., upon the received signals to improve image quality. However, although the above-mentioned noise reduction operations may improve the image quality, under some conditions such as the intensity of the TV signals is weak, using the same degree of the noise reduction operations upon the TV signals may worsen the image quality.

### SUMMARY OF THE INVENTION

It is therefore an objective of the present invention to provide an image processing method and associated image processing apparatus, which can adjust a degree of a noise reduction operation by referring to a sharpness level of a plurality of image frames, to solve the above-mentioned problems.

According to one embodiment of the present invention, an image processing method comprises: receiving a plurality of image frames; receiving a definition signal; and performing an noise reduction operation upon the image frames according to the definition signal, where the definition signal is utilized for representing a sharpness level of the image frames, and a degree of the noise reduction operation the image frames being processed is varied with the sharpness level of the image frames.

According to another embodiment of the present invention, an image processing apparatus comprises a video decoder and an image adjustment unit. The video decoder is utilized for receiving a video signal and decoding the video signal to generate a plurality of image frames. The image adjustment unit is coupled to the video decoder, and is utilized for receiving a definition signal and the image frames, and performing an noise reduction operation upon the image frames according to the definition signal, where the definition signal is utilized for representing a sharpness level of the image frames, and a degree of the noise reduction operation the image frames being processed is varied with the sharpness level of the image frames.

According to another embodiment of the present invention, an image processing method comprises: receiving a plurality of image frames; receiving a definition signal, wherein the definition signal is utilized for representing a sharpness of the image frames; determining a sharpness level of the image frames according to the definition signal; when the sharpness level is a first level, utilizing a first noise reduction method to perform an noise reduction operation upon the image frames; when the sharpness level is a second level, utilizing a second noise reduction method to perform the noise reduction operation upon the image frames, where a degree of the noise reduction operation processed by the first noise reduction method is different from that performed by the second noise reduction method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a receiver according to one embodiment of the present invention.

FIG. 2 is a flow chart of an image processing method according to a first embodiment of the present invention.

FIG. 3 shows two mad windows.

FIG. 4 is a flow chart of an image processing method according to a second embodiment of the present invention.

FIG. 5 is a diagram illustrating performing a temporal noise reduction operation upon an image frame.

FIG. 6 is a flow chart of an image processing method according to a third embodiment of the present invention.

FIG. 7 is a flow chart of an image processing method according to a fourth embodiment of the present invention.

FIG. 8 is a flow chart of an image processing method according to a fifth embodiment of the present invention.

FIG. 9 shows a 3*3 spatial filter.

FIG. 10 is a flow chart of an image processing method according to a sixth embodiment of the present invention.

FIG. 11 shows how to determine an output parameter when a typical coring operation is performed.

FIG. 12 is a diagram illustrating an overall embodiment of the image processing method of the present invention.

### DETAILED DESCRIPTION

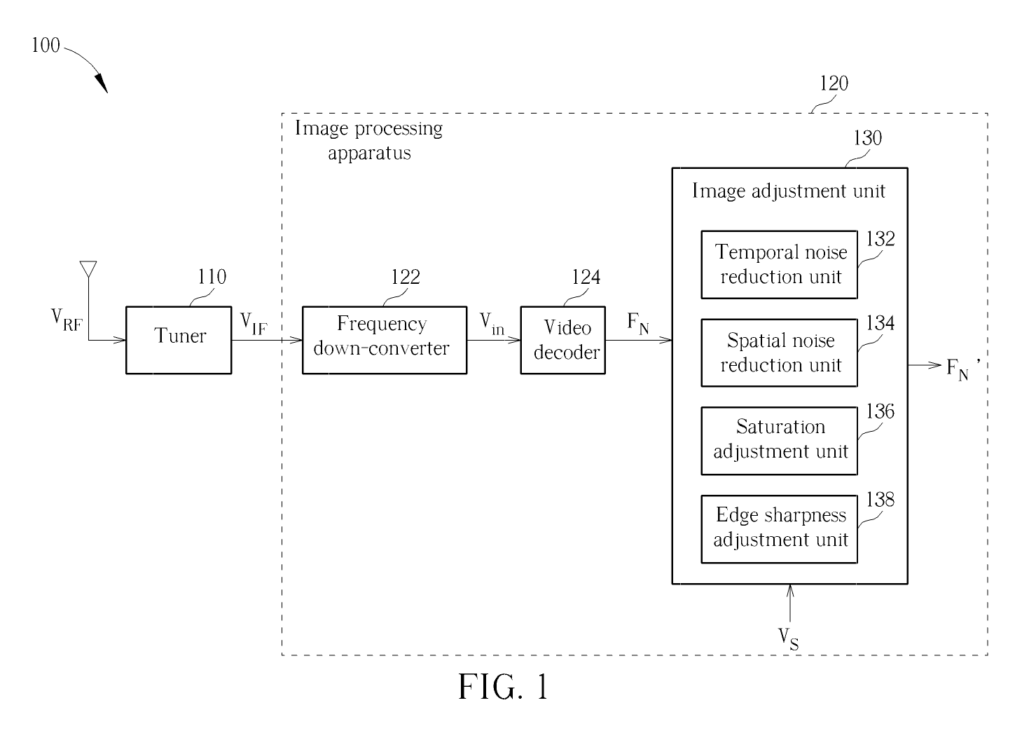

Please refer to FIG. 1, which is a diagram illustrating a receiver 100 according to one embodiment of the present invention. As shown in FIG. 1, the receiver 100 includes a tuner 110 and a image processing apparatus 120, where the image processing apparatus 120 includes a frequency down-converter 122, a video decoder 124 and an image adjustment unit 130, where the image adjustment unit 130 includes at least a temporal noise reduction unit 132, a spatial noise reduction unit 134, a saturation adjustment unit 136 and an edge sharpness adjustment unit 138. In this embodiment, the receiver 100 is a TV receiver, and is used to perform a frequency-down-converting operation, decoding operation and image adjusting operation upon TV video signals, and the processed video signals are shown on a screen of the TV.

In the operations of the receiver 100, the tuner 110 receives a radio frequency (RF) video signal V_{RF} from an antenna, and performs a gain adjustment and frequency down converting operations upon the RF video signal V_{RF} to generate an intermediate frequency (IF) video signal V_{IF}. Then, the frequency down-converter 122 down-converts the IF video signal V_{IF} to generate a baseband video signal Vᵢₙ, and the video decoder 124 decodes the baseband video signal Vᵢₙ to generate a plurality of image frames F_{N}. Then, the temporal noise reduction unit 132, the spatial noise reduction unit 134, the saturation adjustment unit 136 and the edge sharpness adjustment unit 138 of the image adjustment unit 130 perform noise reduction operations upon the image frames F_{N} to generate a plurality of adjusted image frames F_{N}′ according to a definition signal Vs, and the adjusted image frames F_{N}′ will be shown on a screen after being processed by post-circuits.

In the operations of the image adjustment unit 130, a degree of the noise reduction operation performed upon the image frames F_{N} are determined by the definition signal Vs, where the definition signal Vs is used to represent sharpness and/or a quality of being clear and distinct of the image frames F_{N}. For example, because the tuner 110 determines its gain by referring to an intensity of the RF video signal, that is when the intensity of the RF video signal V_{RF} is weak (images are not clear), the gain of the tuner 110 will be set higher to enhance the intensity of the RF video signal V_{RF}, and when the intensity of the RF video signal V_{RF} is great (images are clear), the gain of the tuner 110 will have a lower gain, the gain of the tuner 110 can be used as the definition signal Vs. In addition, a horizontal porch signal or a vertical porch signal corresponding to one of the image frames F_{N}, generated when the video decoder 124 decodes the baseband video signal Vᵢₙ, can also be used as the definition signal Vs, in detail, when an amplitude of the horizontal porch signal or the vertical porch signal is great, it is meant that the intensity of the baseband video signal Vᵢₙ is weak (images are not clear); and when the amplitude of the horizontal porch signal or the vertical porch signal is low, it is meant that the intensity of the baseband video signal Vᵢₙ is great (images are clear). Furthermore, the image adjustment unit 130 can calculate an entropy of a current image frame or a previous image frame to serve as the definition signal Vs, and because a method for calculating the entropy is known by a person skilled in this art, further descriptions are therefore omitted here. In addition, the above-mentioned examples of the definition signal Vs are for illustrative purposes only, and are not meant to be limitations of the present invention.

In addition, the processing order of the temporal noise reduction unit 132, the spatial noise reduction unit 134, the saturation adjustment unit 136 and the edge sharpness adjustment unit 138 of the image adjustment unit 130 is not limited in the present invention, that is, the processing order of the temporal noise reduction unit 132, the spatial noise reduction unit 134, the saturation adjustment unit 136 and the edge sharpness adjustment unit 138 of the image adjustment unit 130 can be determined according to the designer's consideration. In addition, the image adjustment unit 130 can perform other types of noise reduction operations such as an interpolation of the de-interlacing operation.

Several embodiments are provided to describe how the image adjustment unit 130 determines the degree of the noise reduction operation by referring to the definition signal Vs that represents a sharpness level of the image frames F_{N}.

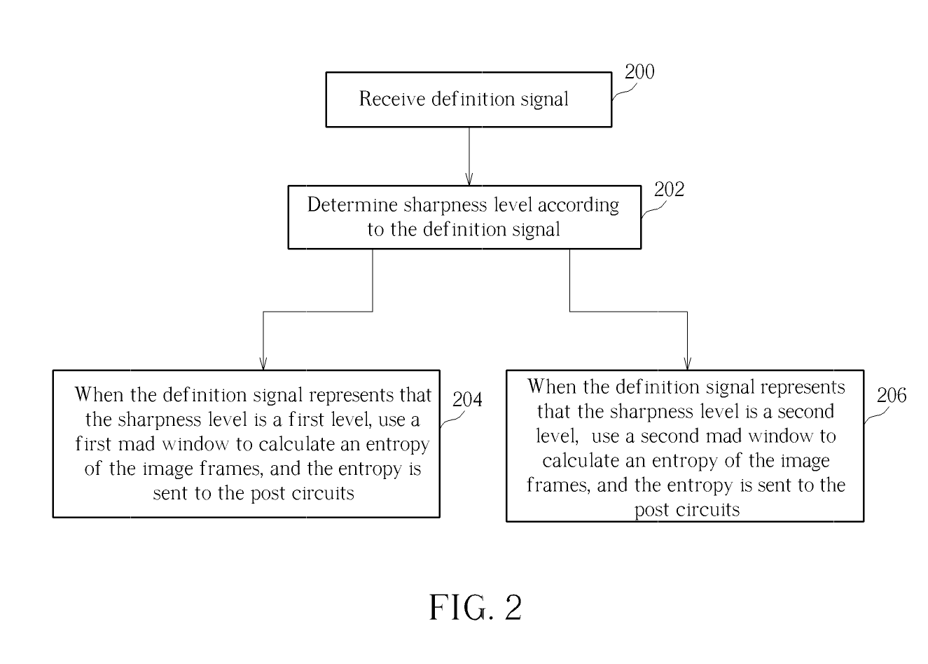

Please refer to FIG. 1 and FIG. 2 together, FIG. 2 is a flow chart of an image processing method according to a first embodiment of the present invention. In Step 200, the image adjustment unit 130 receives the definition signal Vs, where the definition signal Vs is generated outside the image adjustment unit 130, and the definition signal Vs is used to represent a sharpness level of the image frames F_{N}. Then, in Step 202, the image adjustment unit 130 determines the sharpness of the image frames F_{N} by referring to the definition signal Vs, and when the sharpness of the image frames F_{N} is a first level, the flow enters Step 204 to use a first mad window to calculate an entropy of the image frames F_{N}, and the entropy is sent to the post circuits; and when the sharpness of the image frames F_{N} is a second level, the flow enters Step 206 to use a second mad window to calculate an entropy of the image frames F_{N}, and the entropy is sent to the post circuits. The first level of the sharpness is lower than the second level of the sharpness, and a size of the first mad window is smaller than a size of the second mad window.

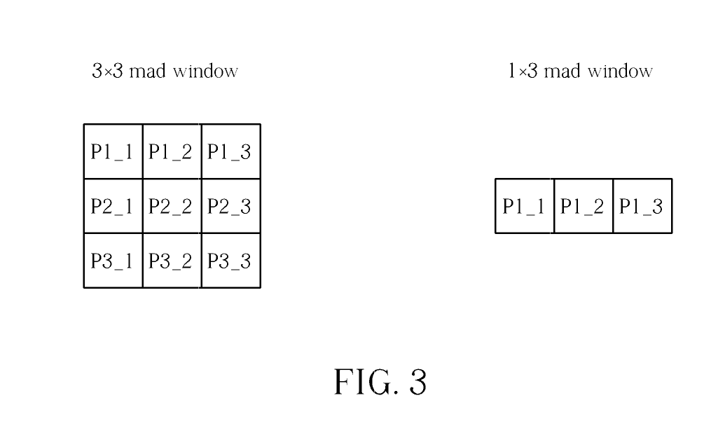

Taking an example to explain the Step 202 shown in FIG. 2, please refer to FIG. 3 which shows a 3*3 mad window and a 1*3 mad window. When the 3*3 mad window is used to calculate the entropy of a target pixel P2_2 of an image frame, the entropy of the target pixel P2_2 can be obtained by calculating a sum of absolute differences between the target pixel P2_2 and its eight neighboring pixels, and similarly, the entropy of the whole image frame can be obtained by using the above-mentioned method to calculate the entropy of all the pixels of the image frame. When the 1*3 mad window is used to calculate the entropy of a target pixel P1_2 of an image frame, the entropy of the target pixel P1_2 can be obtained by calculating a sum of absolute differences between the target pixel P1_2 and its two neighboring pixels, and similarly, the entropy of the whole image frame can be obtained by using the above-mentioned method to calculate the entropy of all the pixels of the image frame. In light of above, for the same image frame, the entropy calculated by using the 3*3 mad window is greater than the entropy calculated by using the 1*3 mad window. Therefore, in Step 202, if the image frames F_{N} have higher sharpness level (image frames F_{N} are clear), the 3*3 mad window is used to calculate the entropy of the image frames F_{N}; and if the image frames F_{N} have lower sharpness level (image frames FN are not clear), the 1*3 mad window is used to calculate the entropy of the image frames F_{N}.

Because the 1*3 mad window is used to calculate the entropy of the image frames F_{N} when the image frames F_{N} have lower sharpness level, the calculated entropy will be deliberately lowered. Therefore, the following image processing unit(s) will consider that the entropy of the image frames is not great, and perform a lower degree of noise reduction operation. In other words, when the image frames F_{N} have lower sharpness level, the calculated entropy will be deliberately lowered to make the following image processing unit(s) (such as the temporal noise reduction unit 132, the spatial noise reduction unit 134, . . . etc.) lower the degree of noise reduction operation to prevent from the problem described in the prior art (i.e., using the same degree of the noise reduction operations upon the image frames may worsen the image quality).

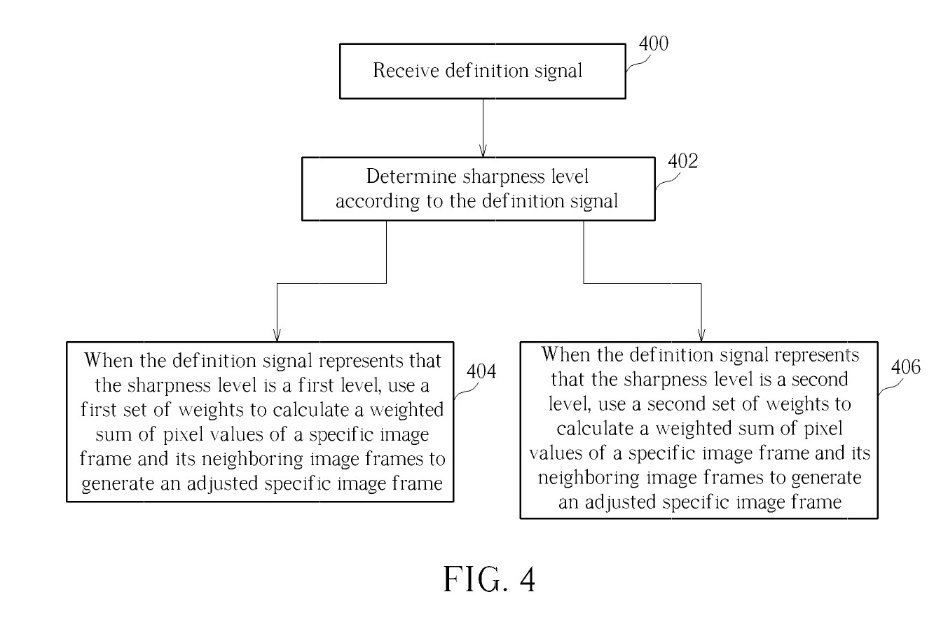

Please refer to FIG. 1 and FIG. 4 together, FIG. 4 is a flow chart of an image processing method according to a second embodiment of the present invention. In Step 400, the image adjustment unit 130 receives the definition signal Vs, where the definition signal Vs is used to represent a sharpness of the image frames F_{N}. Then, in Step 402, the image adjustment unit 130 determines the sharpness of the image frames F_{N} by referring to the definition signal Vs, and when the sharpness of the image frames F_{N} is a first level, the flow enters Step 404; and when the sharpness of the image frames F_{N} is a second level, the flow enters Step 406. In Step 404, for a specific image frame of the image frames F_{N}, the temporal noise reduction unit 132 uses a first set of weights to calculate a weighted sum of the specific image frame and its neighboring image frames to generate an adjusted specific image frame. In Step 406, for the specific image frame, the temporal noise reduction unit 132 uses a second set of weights to calculate a weighted sum of the specific image frame and its neighboring image frames to generate the adjusted specific image frame, where the first set of weights is different from the second et of weights.

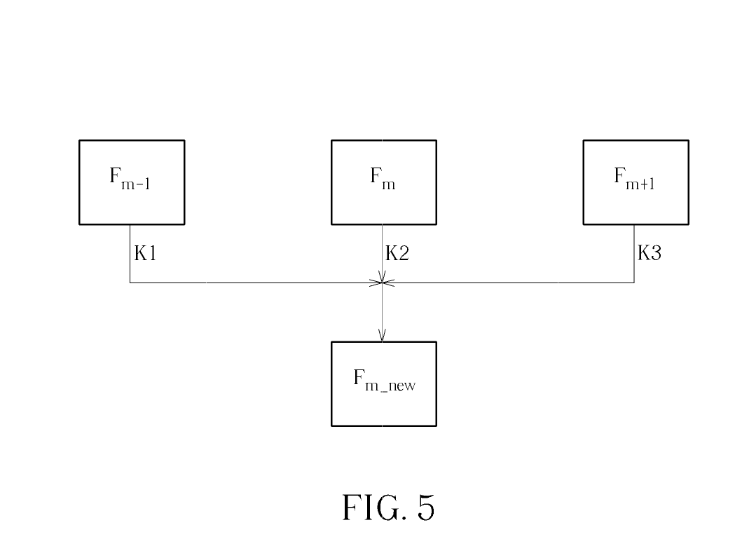

In detail, please refer to FIG. 5 which is a diagram illustrating performing a temporal noise reduction operation upon an image frame. As shown in FIG. 5, when the temporal noise reduction unit 132 performs the temporal noise reduction operation upon the image frame Fₘ to generate an adjusted image frame Fₘ_{_{—}}_{new} by calculating a weighted sum of the image frames Fₘ_{_{—}}_{new}, Fₘ and Fₘ₊₁. For example, for a pixel of the adjusted image frame Fₘ_{_{—}}_{new}, its pixel value P_{new} can be calculated as follows:

P_{new}=K1*Pₘ₋₁+K2*Pₘ+K3*Pₘ₊₁,

where Pₘ₋₁, Pₘ and Pₘ₊₁ are pixel values of pixels of the image frames Fₘ₋₁, Fₘ and Fₘ₊₁, and the pixels of the image frames Fₘ₋₁, Fₘ and Fₘ₊₁ have the same position as the pixel of the adjusted image frame Fₘ_{_{—}}_{new}; and K1, K2, K3 are the weights of the image frames Fₘ₋₁, Fₘ and Fₘ₊₁. Therefore, referring to Steps 402-406, when the image frames F_{N} have higher sharpness level, the weights K1, K2, K3 can be set 0.1, 0.8, 0.1, respectively, that is the weight K2 can be set higher; and when the image frames EN have lower sharpness level, the weights K1, K2, K3 can be set 0.2, 0.6, 0.2, respectively, that is the weight K2 can be set lower.

Generally, the temporal noise reduction operation may cause a side effect “smear”. Therefore, in this embodiment, when the image frames F_{N} have higher sharpness level, the degree of the temporal noise reduction operation can be lowed (i.e., increase the weight K2) to improve the smear issue.

In addition, the above-mentioned pixel values Pₘ₋₁, Pₘ and Pₘ₊₁ can be luminance values or chrominance values.

In addition, please note that, the above-mentioned formula and the amount of the neighboring image frames are for illustrative purposes only, and are not meant to be a limitation of the present invention. As long as at least a portion of weights of the specific image frame and its neighboring image frames are varied with the sharpness level of the image frames F_{N}, the associated alternative designs shall fall within the scope of the present invention.

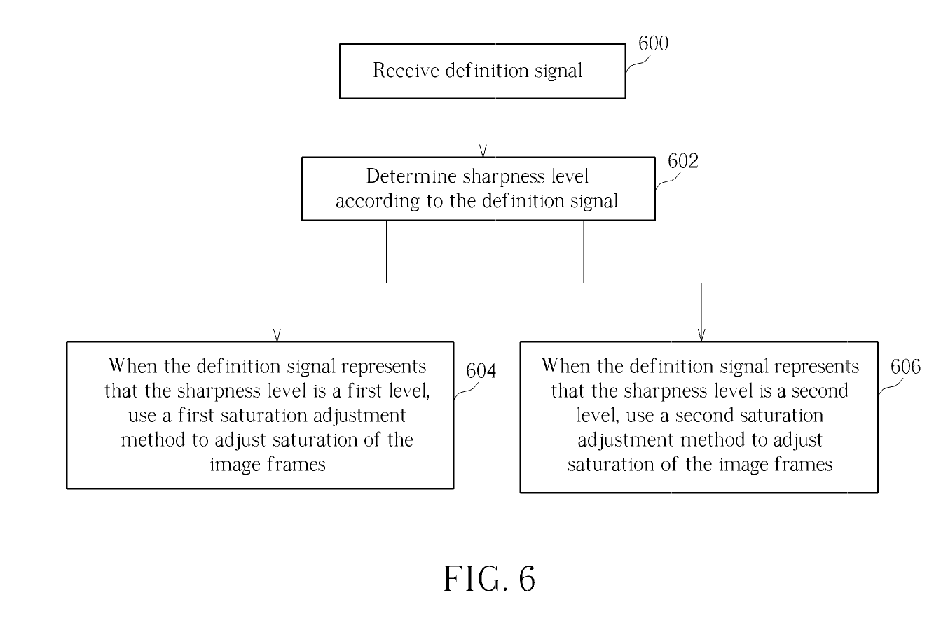

Please refer to FIG. 1 and FIG. 6 together, FIG. 6 is a flow chart of an image processing method according to a third embodiment of the present invention. In Step 600, the image adjustment unit 130 receives the definition signal Vs, where the definition signal Vs is used to represent a sharpness level of the image frames F_{N}. Then, in Step 602, the image adjustment unit 130 determines the sharpness level of the image frames F_{N} by referring to the definition signal Vs, and when the sharpness of the image frames F_{N} is a first level, the flow enters Step 604 to use a first saturation adjusting method to adjust the saturation of the image frames F_{N}; and when the sharpness of the image frames F_{N} is a second level, the flow enters Step 606 to use a second saturation adjusting method to adjust the saturation of the image frames F_{N}.

In detail, when the image frames F_{N} have a higher sharpness level, the saturation adjustment unit 136 uses the saturation adjusting method having greater saturation adjusting amount to adjust the saturation of the image frames F_{N}; and when the image frames F_{N} have a lower sharpness level, the saturation adjustment unit 136 uses the saturation adjusting method having lower saturation adjusting amount to adjust the saturation of the image frames F_{N}. In other words, when the image frames F_{N} have a worse sharpness level, the saturation adjusting amount is lowered to present from the color noise issue.

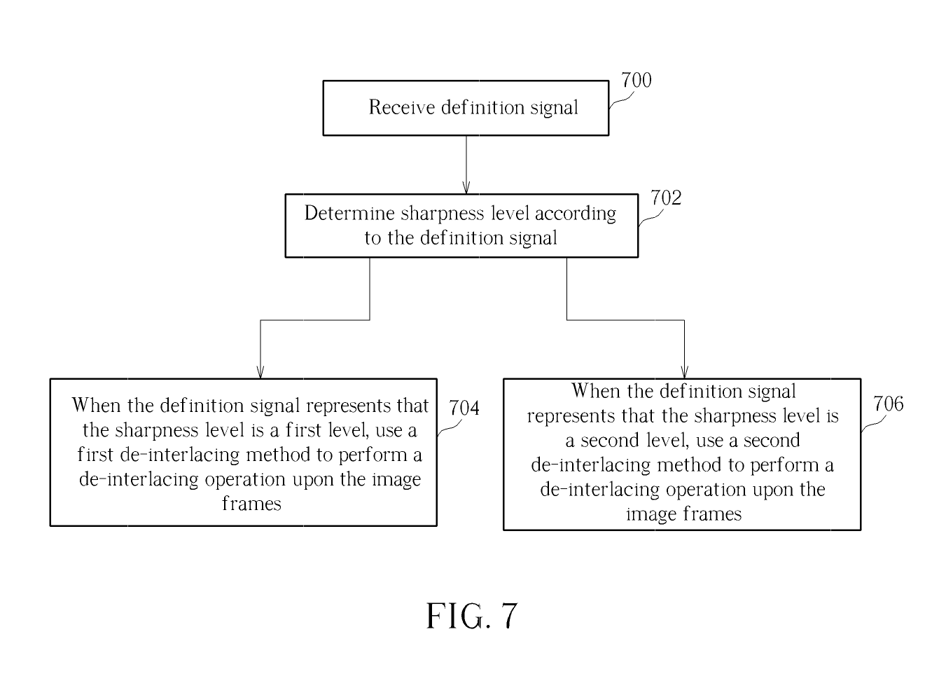

Please refer to FIG. 1 and FIG. 7 together, FIG. 7 is a flow chart of an image processing method according to a fourth embodiment of the present invention. In Step 700, the image adjustment unit 130 receives the definition signal Vs, where the definition signal Vs is used to represent a sharpness level of the image frames F_{N}. Then, in Step 702, the image adjustment unit 130 determines the sharpness level of the image frames F_{N} by referring to the definition signal Vs, and when the sharpness of the image frames F_{N} is a first level, the flow enters Step 704 to use a first de-interlacing method to perform an de-interlacing operation upon the image frames F_{N}; and when the sharpness of the image frames F_{N} is a second level, the flow enters Step 706 to use a second de-interlacing method to perform the de-interlacing operation upon the image frames F_{N}, where the first de-interlacing method is different from the second de-interlacing method.

In detail, generally, in the de-interlacing operation, odd fields and even fields are not directly combined to generate an image frame, instead, an intra-field interpolation or an inter-field interpolation is used during de-interlacing operation to improve the image quality to prevent from a sawtooth image. However, when the image frames F_{N} have worse sharpness level, using the intra-field interpolation or the inter-field interpolation may worsen the image quality. Therefore, in this embodiment, when the image frames F_{N} have higher sharpness level, the first de-interlacing method is used; and when the image frames F_{N} have lower sharpness level, the second de-interlacing method is used, or no intra-field interpolation or/and the inter-field interpolation is used, where the first de-interlacing method and the second de-interlacing method use different intra-field interpolation or/and inter-field interpolation calculating method, and compared with the first de-interlacing method, pixel values of the adjusted image frame processed by the second de-interlacing method are closer to the pixel values of the original odd field and even field.

In light of above, when the image frames F_{N} have the worse sharpness level, the image adjustment unit 130 will use a weak interpolation, or even no interpolation, of the de-interlacing operation. Therefore, the issue “using the intra-field interpolation or the inter-field interpolation may worsen the image quality” can be avoided.

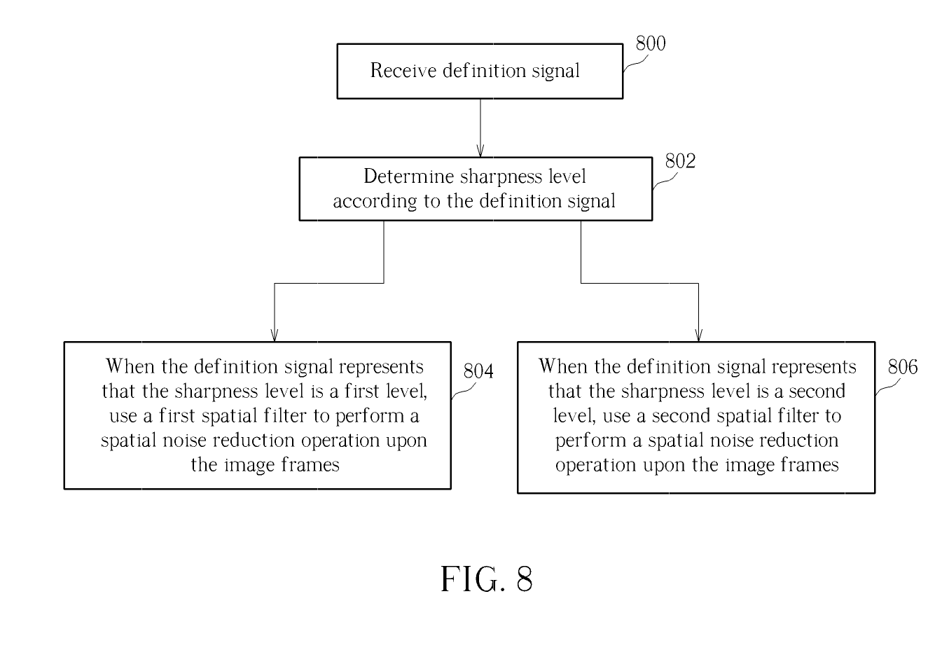

Please refer to FIG. 1 and FIG. 8 together, FIG. 8 is a flow chart of an image processing method according to a fifth embodiment of the present invention. In Step 800, the image adjustment unit 130 receives the definition signal Vs, where the definition signal Vs is used to represent a sharpness level of the image frames F_{N}. Then, in Step 802, the image adjustment unit 130 determines the sharpness of the image frames F_{N} by referring to the definition signal Vs, and when the sharpness of the image frames F_{N} is a first level, the flow enters Step 804 to use a first spatial filter to perform the noise reduction operation upon the image frames F_{N}; and when the sharpness of the image frames F_{N} is a second level, the flow enters Step 606 to use a second spatial filter to perform the noise reduction operation upon the image frames F_{N}, where at least a portion of coefficients of the first spatial filter are different from that of the second spatial filter.

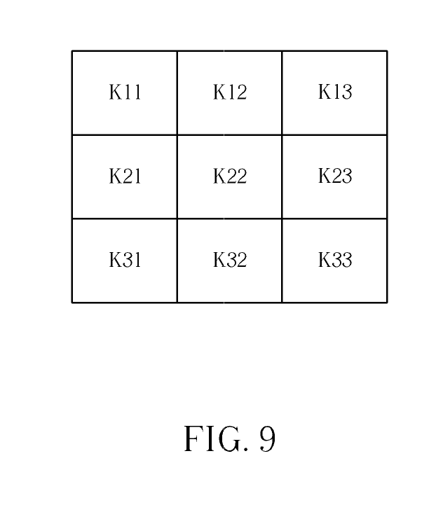

In detail, please refer to FIG. 9 which shows a 3*3 spatial filter. As shown in FIG. 9, the 3*3 spatial filter includes nine coefficients K11-K33, where these nine coefficients K11-K33 are uses as the weights of a central pixel and its eight neighboring pixels. Because how to use the 3*3 spatial filter to adjust a pixel value of the central pixel is known by a person skilled in this art, further details are therefore omitted here. In this embodiment, when the image frames F_{N} have higher sharpness level, the spatial noise reduction unit 134 uses the first spatial filter to perform the noise reduction operation upon the image frames F_{N}; and when the image frames F_{N} have worse sharpness level, the spatial noise reduction unit 134 uses the second spatial filter to perform the noise reduction operation upon the image frames F_{N}, where the weight (coefficient), corresponding to a central pixel, of the first spatial filter is greater than the weight (coefficient), corresponding to the central pixel, of the second spatial filter. That is, the weight (coefficient) K22 of the first spatial filter is greater than the weight (coefficient) K22 of the second spatial filter.

Briefly summarized, in the embodiment shown in FIG. 8, when the image frames F_{N} have higher sharpness level, the spatial noise reduction unit 134 will lower the degree of the noise reduction operation; and when the image frames F_{N} have worse sharpness level, the spatial noise reduction unit 134 will enhance the degree of the noise reduction operation.

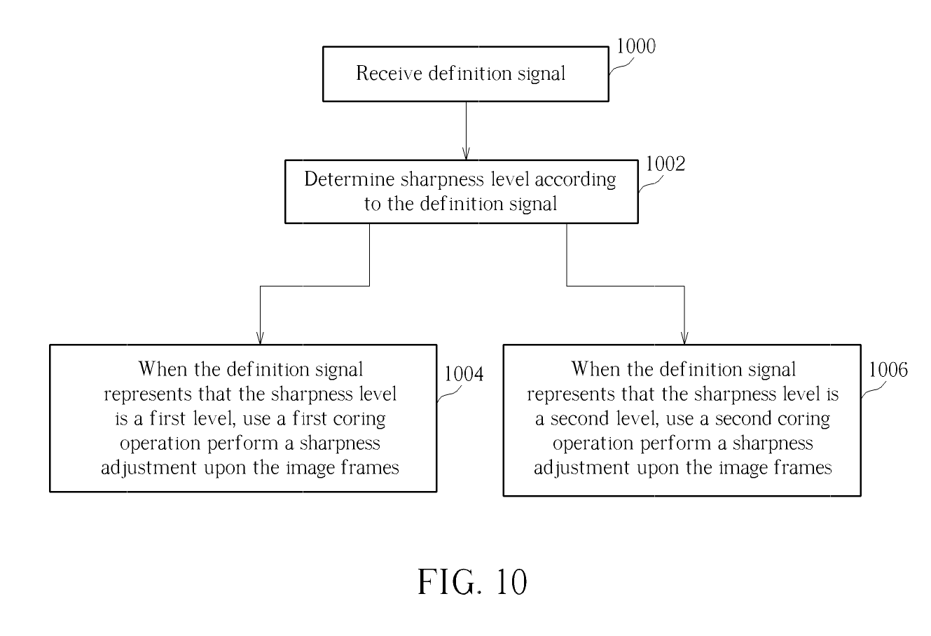

Please refer to FIG. 1 and FIG. 10 together, FIG. 10 is a flow chart of an image processing method according to a sixth embodiment of the present invention. In Step 1000, the image adjustment unit 130 receives the definition signal Vs, where the definition signal Vs is used to represent a sharpness level of the image frames F_{N}. Then, in Step 1002, the image adjustment unit 130 determines the sharpness level of the image frames F_{N} by referring to the definition signal Vs, and when the sharpness of the image frames F_{N} is a first level, the flow enters Step 1004 to use a first coring operation to perform a sharpness adjustment upon the image frames F_{N}; and when the sharpness of the image frames F_{N} is a second level, the flow enters Step 1006 to use a second coring operation to perform the sharpness adjustment upon the image frames F_{N}.

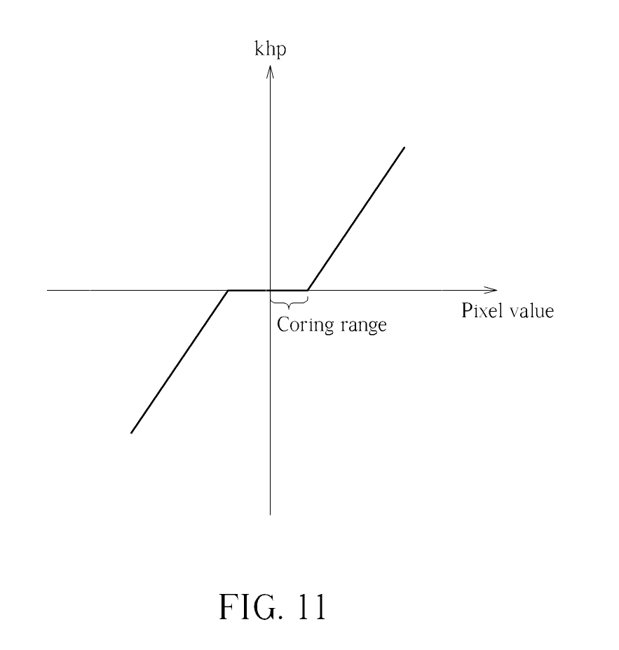

In detail, please refer to FIG. 11 which shows how to determine an output parameter khp when a typical coring operation is performed. Taking an example to describe how to adjust a pixel value of an image frame (not a limitation of the present invention): for each pixel of a high frequency region of the image frame (i.e., the object edges of the image frame), the corresponding output parameter khp can be determined by using its pixel value and diagram shown in FIG. 11, then the adjusted pixel value is determined by using the following formula:

P′=P+P*khp,

where P is the adjusted pixel value and P is the original pixel value.

It is noted that the above-mentioned formula is for illustrative purposes only, and is not meant to be a limitation of the present invention. Referring to FIG. 11, when the pixel value is within a coring range, the output parameter khp equals to zero, that is the pixel value is not adjusted (or the adjusted pixel value is the same as the original pixel value).

In the embodiment shown in FIG. 10, when the image frames F_{N} have higher sharpness level, the coring range of the coring operation used by the edge sharpness adjustment unit 138 is smaller (e.g., coring range is pixel values 0-20), and a slope of the diagonal is greater; and when the image frames F_{N} have worse sharpness level, the coring range of the coring operation used by the edge sharpness adjustment unit 138 is greater (e.g., coring range is pixel values 0-40), and the slope of the diagonal is smaller. Briefly summarized, in the embodiment shown in FIG. 10, when the image frames F_{N} have higher sharpness level, the edge sharpness adjustment unit 138 will enhance the degree of the noise reduction operation (sharpness adjustment); and when the image frames F_{N} have worse sharpness level, the edge sharpness adjustment unit 138 will lower the degree of the noise reduction operation (sharpness adjustment).

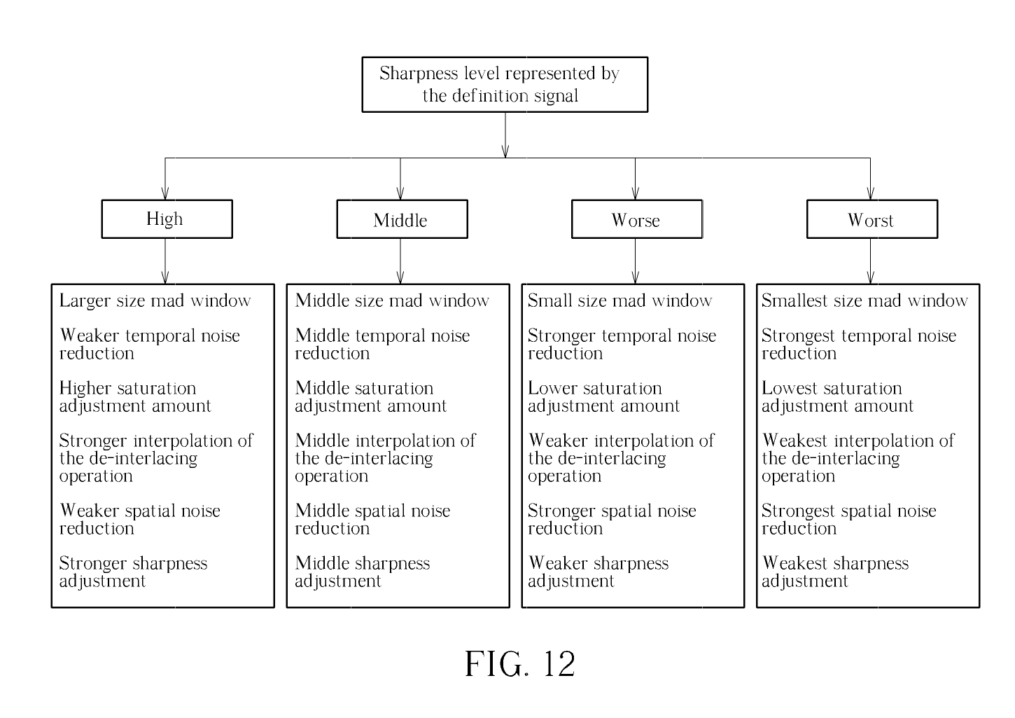

Please refer to FIG. 12, which is a diagram illustrating an overall embodiment of the image processing method of the present invention. As shown in FIG. 12, when the definition signal Vs represents that the sharpness is great, the image adjustment unit 130 uses larger size mad window to calculate the entropy, uses weaker temporal noise reduction, uses higher saturation adjustment amount to adjust the saturation, uses stronger interpolation of the de-interlacing operation, uses weaker spatial noise reduction, and uses stronger sharpness adjustment. When the definition signal Vs represents that the sharpness is a middle level, the image adjustment unit 130 uses middle size mad window to calculate the entropy, uses middle temporal noise reduction, uses middle saturation adjustment amount to adjust the saturation, uses middle interpolation of the de-interlacing operation, uses middle spatial noise reduction, and uses middle sharpness adjustment. When the definition signal Vs represents that the sharpness is worse, the image adjustment unit 130 uses small size mad window to calculate the entropy, uses stronger temporal noise reduction, uses lower saturation adjustment amount to adjust the saturation, uses weaker interpolation of the de-interlacing operation, uses stronger spatial noise reduction, and uses weaker sharpness adjustment. When the definition signal Vs represents that the sharpness is the worst, the image adjustment unit 130 uses smallest size mad window to calculate the entropy, uses strongest temporal noise reduction, uses lowest saturation adjustment amount to adjust the saturation, uses weakest interpolation or no interpolation of the de-interlacing operation, uses strongest spatial noise reduction, and uses weakest sharpness adjustment.

Briefly summarized, in the image processing method and associated image processing apparatus of the present invention, a degree of the noise reduction the image frames are processed is varied due to the sharpness level of the image frames. Therefore, the image frames can be processed by the adequate degree of the noise reduction to obtain the best image quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving a plurality of image frames;
receiving a definition signal; and
performing an noise reduction operation upon the image frames according to the definition signal;
wherein the definition signal is utilized for representing a sharpness level of the image frames, and a degree of the noise reduction operation the image frames being processed is varied with the sharpness level of the image frames.

2. The image processing method of claim 1, wherein the definition signal is a gain value of a tuner, the gain value of the tuner is utilized for adjusting an intensity of a video signal, and the plurality of image frames are generated from the video signal.

3. The image processing method of claim 1, wherein the definition signal is a horizontal porch signal or a vertical porch signal corresponding to one of the image frames.

4. The image processing method of claim 1, further comprising:
calculating an entropy of the image frames to serve as the definition signal.

5. The image processing method of claim 1, wherein the step of performing the noise reduction operation upon the image frames according to the definition signal comprises:
when the definition signal represents that the sharpness level is a first level, utilizing a first mad window to calculate an entropy corresponding to the image frames; and
when the definition signal represents that the sharpness level is a second level, utilizing a second mad window to calculate the entropy corresponding to the image frames;
wherein a sharpness indicated by the first level is lower than a sharpness indicated by the second level, and a size of the first mad window is smaller than a size of the second mad window.

6. The image processing method of claim 1, wherein the image frames comprise a specific image frame, and the step of performing the noise reduction operation upon the image frames according to the definition signal comprises:
calculating a weighted sum of pixel values of the specific image frame and its neighboring image frames to generate an adjusted specific image frame, wherein at least a portion of weights corresponding to the specific image frame and its neighboring image frames are varied with the sharpness level of the image frames.

7. The image processing method of claim 6, wherein the step of calculating the weighted sum of the specific image frame and its neighboring image frames to generate the adjusted specific image frame comprises:
when the definition signal represents that the sharpness level is a first level, utilizing a first set of weights to calculate the weighted sum of the pixel values of the specific image frame and its neighboring image frames to generate the adjusted specific image frame; and
when the definition signal represents that the sharpness level is a second level, utilizing a second set of weights to calculate the weighted sum of the pixel values of the specific image frame and its neighboring image frames to generate the adjusted specific image frame;
wherein a sharpness indicated by the first level is greater than a sharpness indicated by the second level, and a weight, corresponding to the specific image frame, of the first set of weights is greater than a weight, corresponding to the specific image frame, of the second set of weights.

8. The image processing method of claim 6, wherein the pixel values of the specific image frame and its neighboring image frames are luminance values.

9. The image processing method of claim 6, wherein the pixel values of the specific image frame and its neighboring image frames are chrominance values.

10. The image processing method of claim 1, wherein the step of performing the noise reduction operation upon the image frames according to the definition signal comprises:
performing a saturation adjustment upon the image frames according to the definition signal, wherein a degree of the saturation adjustment of the image frames the image frames being processed is varied with the sharpness level of the image frames.

11. The image processing method of claim 10, wherein the step of performing the noise reduction operation upon the image frames according to the definition signal comprises:
when the definition signal represents that the sharpness level is a first level, utilizing a first saturation adjustment method to adjust saturation of the image frames; and
when the definition signal represents that the sharpness level is a second level, utilizing a second saturation adjustment method to adjust the saturation of the image frames;
wherein a sharpness indicated by the first level is greater than a sharpness indicated by the second level, and saturation adjustment amount of the second saturation adjustment method is smaller than saturation adjustment amount of the first saturation adjustment method.

12. The image processing method of claim 1, wherein the step of performing the noise reduction operation upon the image frames according to the definition signal comprises:
performing a de-interlacing operation upon the image frames according to the definition signal, wherein a calculating method of the de-interlacing operation the image frames being processed is varied with the sharpness level of the image frames.

13. The image processing method of claim 12, wherein the step of performing the noise reduction operation upon the image frames according to the definition signal comprises:
when the definition signal represents that the sharpness level is a first level, utilizing a first de-interlacing method to perform the de-interlacing operation upon the image frames; and
when the definition signal represents that the sharpness level is a second level, utilizing a second de-interlacing method to perform the de-interlacing operation upon the image frames;
wherein a sharpness indicated by the first level is greater than a sharpness indicated by the second level, and the first de-interlacing method and the second de-interlacing method use different intra-field interpolation calculating methods.

14. The image processing method of claim 12, wherein the step of performing the noise reduction operation upon the image frames according to the definition signal comprises:
when the definition signal represents that the sharpness level is a first level, utilizing a first de-interlacing method to perform the de-interlacing operation upon the image frames; and
when the definition signal represents that the sharpness level is a second level, utilizing a second de-interlacing method to perform the de-interlacing operation upon the image frames;
wherein a sharpness indicated by the first level is greater than a sharpness indicated by the second level, the first de-interlacing method utilizes an intra-field interpolation calculating method, and the second de-interlacing method does not perform the intra-field interpolation upon the image frames.

15. The image processing method of claim 1, wherein the step of performing the noise reduction operation upon the image frames according to the definition signal comprises:
utilizing a spatial filter to perform a spatial noise reduction operation upon the image frames according to the definition signal, wherein at least a portion of coefficients of the spatial filter are varied with the sharpness level of the image frames.

16. The image processing method of claim 15, wherein the step of utilizing the spatial filter to perform the spatial noise reduction operation upon the image frames according to the definition signal comprises:
when the definition signal represents that the sharpness level is a first level, utilizing a first spatial filter to perform the spatial noise reduction operation upon the image frames; and
when the definition signal represents that the sharpness level is a second level, utilizing a second spatial filter to perform the spatial noise reduction operation upon the image frames;
wherein a sharpness indicated by the first level is greater than a sharpness indicated by the second level, and a coefficient, corresponding to a central pixel, of the first spatial filter is greater than a coefficient, corresponding to the central pixel, of the second spatial filter.

17. The image processing method of claim 1, wherein the step of performing the noise reduction operation upon the image frames according to the definition signal comprises:
performing an edge sharpness adjustment upon the image frames according to the definition signal, wherein a degree of the edge sharpness adjustment the image frames being processed is varied with the sharpness level of the image frames.

18. The image processing method of claim 17, wherein the step of performing the noise reduction operation upon the image frames according to the definition signal comprises:
performing a coring operation upon the image frames according to the definition signal, wherein a coring range utilized in the coring operation the image frames being processed is varied with the sharpness level of the image frames.

19. The image processing method of claim 18, wherein the step of performing the noise reduction operation upon the image frames according to the definition signal comprises:
when the definition signal represents that the sharpness level is a first level, utilizing a first coring range to perform the coring operation upon the image frames; and
when the definition signal represents that the sharpness level is a second level, utilizing a second coring range to perform the coring operation upon the image frames;
wherein a sharpness indicated by the first level is greater than a sharpness indicated by the second level, and the first coring range is smaller than the second coring range.

20. An image processing apparatus, comprising:
a video decoder, for receiving a video signal and decoding the video signal to generate a plurality of image frames; and
an image adjustment unit, coupled to the video decoder, for receiving a definition signal and the image frames, and performing an noise reduction operation upon the image frames according to the definition signal; wherein the definition signal is utilized for representing a sharpness level of the image frames, and a degree of the noise reduction operation the image frames being processed is varied with the sharpness level of the image frames.

21. The image processing apparatus of claim 20, wherein the definition signal is a gain value of a tuner, the gain value of the tuner is utilized for adjusting an intensity of a video signal.

22. The image processing apparatus of claim 20, wherein the definition signal is a horizontal porch signal or a vertical porch signal corresponding to one of the image frames.

23. The image processing apparatus of claim 20, wherein when the definition signal represents that the sharpness level is a first level, the image adjustment unit utilizes a first mad window to calculate an entropy corresponding to the image frames; and when the definition signal represents that the sharpness level is a second level, the image adjustment unit utilizes a second mad window to calculate the entropy corresponding to the image frames; wherein a sharpness indicated by the first level is lower than a sharpness indicated by the second level, and a size of the first mad window is smaller than a size of the second mad window.

24. The image processing apparatus of claim 20, wherein the image frames comprise a specific image frame, and the image adjustment unit calculates a weighted sum of pixel values of the specific image frame and its neighboring image frames to generate an adjusted specific image frame, where at least a portion of weights corresponding to the specific image frame and its neighboring image frames are varied with the sharpness level of the image frames.

25. The image processing apparatus of claim 20, wherein the image adjustment unit performs a saturation adjustment upon the image frames according to the definition signal, wherein a degree of the saturation adjustment of the image frames the image frames being processed is varied with the sharpness level of the image frames.

26. The image processing apparatus of claim 20, wherein the image adjustment unit performs a de-interlacing operation upon the image frames according to the definition signal, where a calculating method of the de-interlacing operation the image frames being processed is varied with the sharpness level of the image frames.

27. The image processing apparatus of claim 20, wherein the image adjustment unit utilizes a spatial filter to perform a spatial noise reduction operation upon the image frames according to the definition signal, where at least a portion of coefficients of the spatial filter are varied with the sharpness level of the image frames.

28. The image processing apparatus of claim 20, wherein the image adjustment unit performs an edge sharpness adjustment upon the image frames according to the definition signal, where a degree of the edge sharpness adjustment the image frames being processed is varied with the sharpness level of the image frames.

29. An image processing method, comprising:
receiving a plurality of image frames;
receiving a definition signal, wherein the definition signal is utilized for representing a sharpness of the image frames;
determining a sharpness level of the image frames according to the definition signal;
when the sharpness level is a first level, utilizing a first noise reduction method to perform an noise reduction operation upon the image frames;
when the sharpness level is a second level, utilizing a second noise reduction method to perform the noise reduction operation upon the image frames;
wherein a degree of the noise reduction operation processed by the first noise reduction method is different from that performed by the second noise reduction method.

30. The image processing method of claim 29, wherein the definition signal is a gain value of a tuner, the gain value of the tuner is utilized for adjusting an intensity of a video signal, and the plurality of image frames are generated from the video signal.

31. The image processing method of claim 29, wherein the definition signal is a horizontal porch signal or a vertical porch signal corresponding to one of the image frames.

32. The image processing method of claim 29, further comprising:
calculating an entropy of the image frames to serve as the definition signal.

33. The image processing method of claim 29, wherein each of the first noise reduction method and the second noise reduction method comprises at least an entropy calculating operation, wherein:
when the sharpness level is a first level, utilizing a first mad window to calculate an entropy corresponding to the image frames; and
when the sharpness level is a second level, utilizing a second mad window to calculate the entropy corresponding to the image frames;
wherein a sharpness indicated by the first level is lower than a sharpness indicated by the second level, and a size of the first mad window is smaller than a size of the second mad window.

34. The image processing method of claim 29, wherein the image frames comprise a specific image frame, each of the first noise reduction method and the second noise reduction method comprises at least a temporal noise reduction operation, wherein:
when the sharpness level is a first level, utilizing a first set of weights to calculate the weighted sum of pixel values of the specific image frame and its neighboring image frames to generate the adjusted specific image frame; and
when the sharpness level is a second level, utilizing a second set of weights to calculate the weighted sum of the pixel values of the specific image frame and its neighboring image frames to generate the adjusted specific image frame;
wherein a sharpness indicated by the first level is greater than a sharpness indicated by the second level, and a weight, corresponding to the specific image frame, of the first set of weights is greater than a weight, corresponding to the specific image frame, of the second set of weights.

35. The image processing method of claim 29, wherein each of the first noise reduction method and the second noise reduction method comprises at least a saturation adjustment operation, wherein:
when the sharpness level is a first level, utilizing a first saturation adjustment method to adjust saturation of the image frames; and
when the sharpness level is a second level, utilizing a second saturation adjustment method to adjust the saturation of the image frames;
wherein a sharpness indicated by the first level is greater than a sharpness indicated by the second level, and saturation adjustment amount of the second saturation adjustment method is smaller than saturation adjustment amount of the first saturation adjustment method.

36. The image processing method of claim 29, wherein each of the first noise reduction method and the second noise reduction method comprises at least a de-interlacing operation, wherein:
when the sharpness level is a first level, utilizing a first de-interlacing method to perform the de-interlacing operation upon the image frames; and
when the sharpness level is a second level, utilizing a second de-interlacing method to perform the de-interlacing operation upon the image frames;
wherein a sharpness indicated by the first level is greater than a sharpness indicated by the second level, and the first de-interlacing method and the second de-interlacing method use different intra-field interpolation calculating methods.

37. The image processing method of claim 29, wherein each of the first noise reduction method and the second noise reduction method comprises at least a spatial noise reduction operation, wherein:
when the sharpness level is a first level, utilizing a first spatial filter to perform the spatial noise reduction operation upon the image frames; and
when the sharpness level is a second level, utilizing a second spatial filter to perform the spatial noise reduction operation upon the image frames;
wherein a sharpness indicated by the first level is greater than a sharpness indicated by the second level, and a coefficient, corresponding to a central pixel, of the first spatial filter is greater than a coefficient, corresponding to the central pixel, of the second spatial filter.

38. The image processing method of claim 29, wherein each of the first noise reduction method and the second noise reduction method comprises at least a sharpness adjustment operation, wherein:
when the sharpness level is a first level, utilizing a first coring range to perform the coring operation upon the image frames; and
when the sharpness level is a second level, utilizing a second coring range to perform the coring operation upon the image frames;
wherein a sharpness indicated by the first level is greater than a sharpness indicated by the second level, and the first coring range is smaller than the second coring range.
